(19) United States
(12) Patent Application Publication
(10) Pub. No.: US 2019/0043065 A1
(43) Pub. Date: Feb. 7, 2019

(54) METHOD AND SYSTEM OF FACILITATING RECOMMENDATION OF DIGITAL CONTENT BASED ON USER RESPONSES

(71) Applicant: John Hall, Charlotte, NC (US)

(72) Inventor: John Hall, Charlotte, NC (US)

(21) Appl. No.: 16/054,828

(22) Filed: Aug. 3, 2018

Related U.S. Application Data
(60) Provisional application No. 62/541,527, filed on Aug. 4, 2017.

(51) Int. Cl. G06Q 30/02; G06Q 30/06; G06F 17/30

(52) U.S. Cl. CPC G06Q 30/0201; G06F 17/3053; G06Q 30/0631

(57) ABSTRACT

A method of facilitating recommendation of digital content based on user responses is provided. The method may include receiving, using a communication device, a plurality of digital content from a provider device and transmitting, using a communication device, the plurality of digital content to a recipient device. Further, the method may include receiving, using a communication device, at least one response from the recipient device. Further, the method may include analyzing, using a processing device, the at least one response. Further, the method may include identifying, using the processing device, at least one preferred digital content based on the analyzing. Further, the method may include storing, using a storage device, the at least one preferred digital content. Further, the method may include transmitting, using the communication device, the at least one preferred digital content to a provider device.

The current application claims a priority to the U.S. Provisional Patent application Ser. No. 62/541,527 filed on Aug. 4, 2017.

### FIELD OF THE INVENTION

The present disclosure relates generally to the field of data processing. More specifically, the present disclosure relates to recommending digital content based on user responses.

### BACKGROUND OF THE INVENTION

Most people find it challenging to select a gift to give to someone. Presently, there is no way to know, in a discrete and anonymous manner, whether a selected gift will be valued by the receiver. Therefore, people resort to guessing the best gift for the receiver.

The most challenging aspect is to know how much the receiver may appreciate the gift bought for them. If it is known how the receiver may appreciative the different gifts picked before purchase, it may increase the satisfaction among both parties. There is, however, no way currently to collect this data and the means to request directly but anonymously what the receiver may most desire as a gift without exposing the identity of the first party willing to impart the gift.

Therefore, there is a need for improved methods and systems to anonymously obtain a response from a receiver about a gift before purchasing the gift that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method of facilitating recommendation of digital content based on user responses is provided. The method may include receiving, using a communication device, a plurality of digital content from a provider device. Further, the method may include transmitting, using the communication device, the plurality of digital content to a recipient device. Further, the recipient device may be configured to present the plurality of digital content. Further, the method may include receiving, using the communication device, at least one response from the recipient device. Further, the at least one response may be associated with the plurality of digital content. Further, the recipient device may include at least one response capturing device configured to capture the at least one response. Further, the method may include analyzing, using a processing device, the at least one response. Further, the method may include identifying, using the processing device, at least one preferred digital content based on the analyzing. Further, the method may include storing, using a storage device, the at least one preferred digital content. Further, the method may include transmitting, using the communication device, the at least one preferred digital content to a provider device.

Further, according to some embodiments, a system for facilitating recommendation of digital content based on user responses is also disclosed. The system may include a communication device configured for receiving a plurality of digital content from a provider device and transmitting the plurality of digital content to a recipient device. Further, the recipient device may be configured to present the plurality of digital content. Further, the communication device may be configured for receiving at least one response from the recipient device. Further, the at least one response may be associated with the plurality of digital content. Further, the recipient device may include at least one response capturing device configured to capture the at least one response. Further, the communication device may be configured for transmitting at least one preferred digital content to a provider device. Further, the system may include a processing device configured for analyzing the at least one response. Further, the processing device may be configured for identifying the at least one preferred digital content based on the analyzing. Further, the system may include a storage device configured for storing the at least one preferred digital content.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating recommendation of digital content based on user responses in accordance with some embodiments.

FIG. 3 is a flowchart of a method of facilitating recommendation of digital content based on user responses in accordance with some embodiments.

FIG. 4 is a flowchart of a method of processing a purchase request, in accordance with some embodiments.

FIG. 5 is a flowchart of a method of determining at least one interest associated with the recipient, in accordance with some embodiments.

FIG. 6 is a flowchart of a method of providing digital content, in accordance with some embodiments.

FIG. 7 is a flowchart of a method for offering and receiving validation of a gift through an anonymous masking protocol, in accordance with some embodiments.

FIG. 8 is a flowchart of a method for initiating a registration phase, in accordance with some embodiments.

FIG. 9 is a flowchart of a method for initiating a selection-aggregation phase, in accordance with some embodiments.

FIG. 10 is a flowchart of a method for initiating a correspondence phase, in accordance with some embodiments.

FIG. 11 is a flowchart of a method for initiating a confirmation phase, in accordance with some embodiments.

FIG. 12 is a flowchart of a method for initiating a verification phase, in accordance with some embodiments.

FIG. 13 is a flowchart of a method for initiating an optional financial vendor phase, in accordance with some embodiments.

FIG. 14 illustrates a system for offering and receiving validation of a gift through an anonymous masking protocol, in accordance with some embodiments.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of recommending digital content, embodiments of the present disclosure are not limited to use only in this context.

Overview

According to some embodiments, the present disclosure relates generally to an application and a third party service that facilitates the anonymous gifting between two parties through a third party mediating entity and a protocol conducted during the course of regular online browsing by the two parties, particularly by amassing a collection of gift preferences and acquiring feedback from the intended receiver of the gift and even more particularly where the gift giver may be able to send a large archived basket of gift ideas to the receiving party anonymously.

According to some embodiments, disclosed is a method that allows the correspondence between two parties to be mediated by a third party that masks the first party, a registered user of the system, from a second party, an optionally registered second user of the system or otherwise a non-descript entity unknown initially to the program and protocol, at all operations of the protocol. The first party may then select and aggregate a plurality of browsable articles through the program established on their computer by installation prior to the operation and registration phase to aggregate a second data set and optionally establish a third data set by parsing interest parameters associated with the browsable articles selected, optionally the second party as a user may establish their own second and third data sets through operation of the program if they are registered. These second and third data sets of the first party may then be called upon to select and mark the gifts the user is willing to offer to the second unaware party and subsequently masked prior to forwarding and notifying the second party. Thereafter the second party may take the unprecedented step of selecting, rating, or even offering their own desired gifts to be forwarded to the first party. Thereafter, the first party is presented with a precise array of items the second party may be most enthusiastic to receive without having discerned the first party and the first party may then select such items at their own leisure or in an enhanced embodiment, systems are presented that may automate or expedite the purchase of gifts with confirmation by the user before a verification is notified to the second party that a gift is inbound.

Accordingly, the present disclosure circumvents the typical hassle of trying to select a suitable and appreciated gift for a second party without alerting the second party of the first party's identity, additionally receiving input of the second party in the protocol thereof. With additional protocol enhancements, the anonymity of the exchange may be strengthened by directly but discretely authorizing the purchase and shipment of the item by operating autonomously through a third party operating through a remote server and algorithmic operation and optimization.

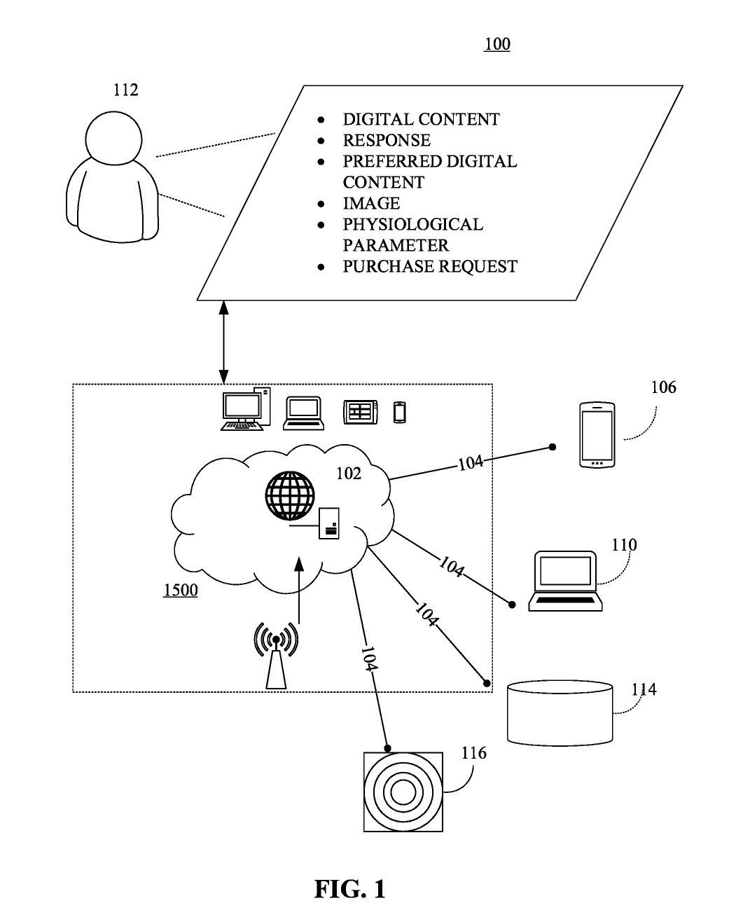

Referring now to figures, FIG. 1 is an illustration of an online platform 100 consistent with various embodiments of the present disclosure. By way of non-limiting example, the online platform 100 to facilitate recommendation of digital content based on user responses may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (such as databases associated with e-commerce platforms), and sensors 116 (such as a camera sensor, a physiological sensor, or a sensor in an IoT device), over a communication network 104, such as, but not limited to, the Internet. Further, users of the online platform 100 may include relevant parties such as, but not limited to, end users, employees at e-commerce companies, administrators. Accordingly, in some instances, electronic devices operated by the one or more relevant parties may be in communication with the platform 100.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1500.

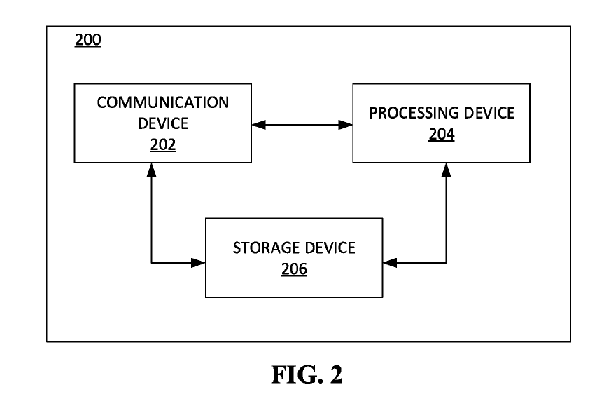

FIG. 2 is a block diagram of a system 200 for facilitating recommendation of digital content based on user responses in accordance with some embodiments. The system 200 may include a communication device 202 configured for receiving a plurality of digital content from a provider device. In general, the plurality of digital content digital content may include one or more of textual content, image content, audio content, video content, multimedia content, virtual reality content, augmented reality content and so on. In some embodiments, the plurality of digital content may be associated with a plurality of products and/or services. Accordingly, in an instance, a provider operating the provider device may wish to consider purchasing and/or gifting one or more of the plurality of products and/or services to a recipient of the recipient device. Accordingly, the plurality of digital content may represent the plurality of products and/or services. For example, a digital content associated with a product may include a textual content including a name and a description of the product and an image content including a picture of the product.

In some other embodiments, the plurality of digital content may correspond to a plurality of options associated with an offering. In general, the offering may refer to any experience provided to the recipient. In an instance, the plurality of options may be specified by a provider associated with the provider device. Further, in some instances, the provider may facilitate provisioning of the offering to the recipient. For example, the offering may include provisioning of a physical object, such as a gift. Accordingly, in some instances, the provider may facilitate provisioning of the gift by purchasing the gift. In another example, the offering may include a provisioning of items such as tickets, coupons etc. to facilitate an experience for the recipient such as traveling, attending an event/concert, visit to a museum etc. In yet another example, the offering may include provisioning of a surprise such as a marriage proposal, a prank etc.

Further, the communication device 202 may be configured for transmitting the plurality of digital content to a recipient device. Further, the recipient device may be configured to present the plurality of digital content.

Further, the communication device 202 may be configured for receiving at least one response from the recipient device. Further, the at least one response may be associated with the plurality of digital content. In general, the at least one response may refer to a behavioral reaction exhibited by the recipient in response to the presentation of the plurality of digital content. In an instance, the behavioral reaction may include one or more of a voluntary reaction (e.g. a like action, a rating etc.) and an involuntary reaction (e.g. change in facial expression, change in body posture/language, dilation/contraction of pupils, change in physiological variables such as heart rate, blood pressure, breathing rate, brain waves (i.e. EEG) etc.

Further, the recipient device may include at least one response capturing device configured to capture the at least one response. In some embodiments, the at least one response capturing device may include an input device configured to receive an input from a recipient of the recipient device. In general, the input device may be any device configured to facilitate the recipient to provide a voluntary action representing the at least one response. For example, the input device may include, but is not limited to, a keyboard, a touchscreen, a microphone, a camera, a motion sensor, a gesture detector and so on.

In some embodiments, the at least one response capturing device may include an image capturing device configured to capture at least one image of a recipient of the recipient device in response to presentation of at least one digital content of the plurality of digital content. The at least one image may, in general, represent a behavioral reaction of the recipient to the plurality of digital content. For instance, the behavioral reaction may include a change in facial expression, a change in body posture/language, dilation/contraction of pupils, etc.

In some embodiments, the at least one response capturing device may include a physiological sensor configured to detect at least one physiological variable of a recipient of the recipient device in response to presentation of at least one digital content of the plurality of digital content.

In some embodiments, the at least one response capturing device may include an IoT device configured to detect one or more offline behavior of a recipient of the recipient device in an environment. Further, identifying of at least one preferred digital content may be based on the one or more offline behavior. In general, an IoT device may be any electronic device comprising at least one sensor configured to sense at least one environmental variable and a wireless and/or wired transmitter configured to transmit sensor data from the at least one sensor to a computing device (e.g. a server computer). Further, the at least one offline behavior may be captured without necessarily presenting the plurality of digital content to the recipient. For example, the IoT device may include a wearable computer such as an activity tracker. Accordingly, the sensor data generated by the activity tracker may be analyzed to determine the at least one offline behavior (e.g. regular running). Accordingly, in an instance, one or more gifts (e.g. running shoes, wireless earphones, etc.) that are more suited for a runner may be identified.

Further, the communication device 202 may be configured for transmitting at least one preferred digital content to a provider device.

Moreover, the system 200 may include a processing device 204 configured for analyzing the at least one response. Further, the processing device 204 may be configured for identifying the at least one preferred digital content based on the analyzing. In some embodiments, the at least one preferred digital content may be determined based on a preference criterion specified by the provider. For example, the preference criterion may include interest. Accordingly, the at least one preferred digital content identified may be of interest to the recipient. In another example, the preference criterion may further include a specification of a desired emotional response (e.g. surprise, joy, confusion etc.). Accordingly, the at least one preferred digital content identified may elicit the desired emotional response.

Further, the system 200 may include a storage device 206 configured for storing the at least one preferred digital content.

In some embodiments, the communication device 202 may be further configured for receiving a purchase request from the provider device. Further, the purchase request may be associated with one or more of a product and a service represented by the at least one preferred digital content. Further, the processing device 204 may be configured for provisioning one or more of the product and the service to the recipient based on the purchase request.

In some embodiments, the at least one response may include a plurality of rankings corresponding to the plurality of digital content. Further, identifying of the at least one preferred digital content may be based on the plurality of rankings.

In some embodiments, the communication device 202 may be further configured for receiving online activity data associated with the recipient from a computing device. In some embodiments, the computing device may include the recipient device. Accordingly, the online activity data may be captured and stored at the recipient device. Further, in some embodiments, the computing device may include a server computer configured to provide one or more services to the recipient device. Accordingly, the server computer may monitor the activity of the recipient and generate the online activity data and subsequently transmit the online activity data to the online platform 100. Further, the processing device 204 may be configured for analyzing the online activity data and identifying at least one interest associated with the recipient based on the analyzing of the online activity data. Further, the identifying of the at least one preferred digital content may be based on the at least one interest. Accordingly, in some embodiments, subsequent to the user providing rankings to the plurality of digital content, the at least one interest may be used to modify the rankings.

In some embodiments, the communication device 202 may be configured for establishing a communication session between the provider device and the recipient device. Further, an identity of the provider may be anonymized.

In some embodiments, the communication device 202 may be further configured for receiving online activity data associated with the recipient from a computing device. In some embodiments, the computing device may include the recipient device. Accordingly, the online activity data may be captured and stored at the recipient device. Further, in some embodiments, the computing device may include a server computer configured to provide one or more services to the recipient device. Accordingly, the server computer may monitor the activity of the recipient and generate the online activity data and subsequently transmit the online activity data to the online platform 100.

Further, the communication device 202 may be configured for transmitting a plurality of recommended digital content to the provider device. In some embodiments, the online platform 100 may provide a list of recommended digital content to the provider to choose the plurality of digital content. Further, the list may be generated based on one or more interests of the recipient as gleaned from the recipient's online activity.

Further, the communication device 202 may be configured for receiving an indication of the plurality of digital content from the provider device. Further, the plurality of recommended digital content may include the plurality of digital content.

Further, the processing device 204 may be configured for analyzing the online activity data, identifying at least one interest associated with the recipient based on the analyzing of the online activity data and identifying the plurality of recommended digital content based on the at least one interest.

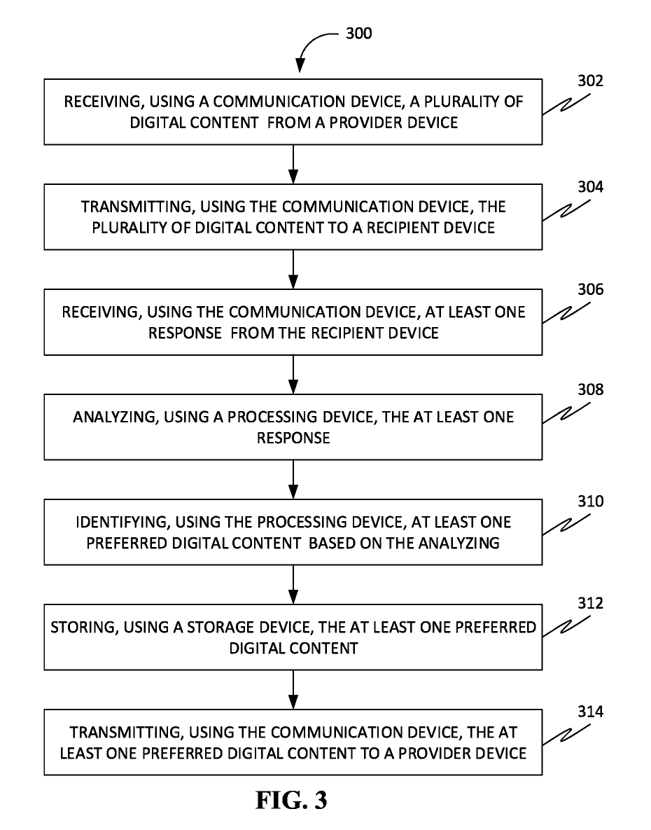

FIG. 3 is a flowchart of a method 300 of facilitating recommendation of digital content based on user responses, in accordance with some embodiments. Accordingly, at 302, the method 300 may include receiving, using a communication device (such as the communication device 202), a plurality of digital content from a provider device. In general, the plurality of digital content may include one or more of textual content, image content, audio content, video content, multimedia content, virtual reality content, augmented reality content and so on. In some embodiments, the plurality of digital content may be associated with a plurality of products and/or services. Accordingly, in an instance, a provider operating the provider device may wish to consider purchasing and/or gifting one or more of the plurality of products and/or services to a recipient of the recipient device. Accordingly, the plurality of digital content may represent the plurality of products and/or services. For example, a digital content associated with a product may include a textual content including a name and a description of the product and an image content including a picture of the product.

In some other embodiments, the plurality of digital content may correspond to a plurality of options associated with an offering. In general, the offering may refer to any experience provided to the recipient. In an instance, the plurality of options may be specified by a provider associated with the provider device. Further, in some instances, the provider may facilitate provisioning of the offering to the recipient. For example, the offering may include provisioning of a physical object, such as a gift. Accordingly, in some instances, the provider may facilitate provisioning of the gift by purchasing the gift. In another example, the offering may include a provisioning of items such as tickets, coupons etc. to facilitate an experience for the recipient such as traveling, attending an event/concert, visit to a museum etc. In yet another example, the offering may include provisioning of a surprise such as a marriage proposal, a prank etc.

At 304, the method 300 may include transmitting, using the communication device, the plurality of digital content to a recipient device. Further, the recipient device may be configured to present the plurality of digital content.

At 306, the method 300 may include receiving, using the communication device, at least one response from the recipient device. Further, the at least one response may be associated with the plurality of digital content. Further, the recipient device may include at least one response capturing device configured to capture the at least one response. In general, the at least one response may refer to a behavioral reaction exhibited by the recipient in response to the presentation of the plurality of digital content. In an instance, the behavioral reaction may include one or more of a voluntary reaction (e.g. a like action, a rating etc.) and an involuntary reaction (e.g. change in facial expression, change in body posture/language, dilation/contraction of pupils, change in physiological variables such as heart rate, blood pressure, breathing rate, brain waves (i.e. EEG) etc.

In some embodiments, the at least one response capturing device may include an input device configured to receive an input from a recipient of the recipient device. In general, the input device may be any device configured to facilitate the recipient to provide a voluntary action representing the at least one response. For example, the input device may include, but is not limited to, a keyboard, a touchscreen, a microphone, a camera, a motion sensor, a gesture detector and so on.

In some embodiments, the at least one response capturing device may include an image capturing device configured to capture at least one image of a recipient of the recipient device in response to presentation of at least one digital content of the plurality of digital content. The at least one image may, in general, represent a behavioral reaction of the recipient to the plurality of digital content. For instance, the behavioral reaction may include a change in facial expression, a change in body posture/language, dilation/contraction of pupils, etc.

In some embodiments, the at least one response capturing device may include a physiological sensor configured to detect at least one physiological variable of a recipient of the recipient device in response to presentation of at least one digital content of the plurality of digital content.

In some embodiments, the at least one response capturing device may include an IoT device configured to detect one or more offline behavior of a recipient of the recipient device in an environment. Further, identifying of at least one preferred digital content may be based further on the one or more offline behavior. In general, an IoT device may be any electronic device comprising at least one sensor configured to sense at least one environmental variable and a wireless and/or wired transmitter configured to transmit sensor data from the at least one sensor to a computing device (e.g. a server computer). Further, the at least one offline behavior may be captured without necessarily presenting the plurality of digital content to the recipient. For example, the IoT device may include a wearable computer such as an activity tracker. Accordingly, the sensor data generated by the activity tracker may be analyzed to determine the at least one offline behavior (e.g. regular running). Accordingly, in an instance, one or more gifts (e.g. running shoes, wireless earphones, etc.) that are more suited for a runner may be identified.

At 308, the method 300 may include analyzing, using a processing device (such as the processing device 204), the at least one response.

At 310, the method 300 may include identifying, using the processing device, at least one preferred digital content based on the analyzing. In some embodiments, the at least one preferred digital content may be determined based on a preference criterion specified by the provider. For example, the preference criterion may include interest. Accordingly, the at least one preferred digital content identified may be of interest to the recipient. In another example, the preference criterion may further include a specification of a desired emotional response (e.g. surprise, joy, confusion etc.). Accordingly, the at least one preferred digital content identified may elicit the desired emotional response.

In some embodiments, the at least one response may include a plurality of rankings corresponding to the plurality of digital content. Further, identifying of the at least one preferred digital content (at 310) may be based on the plurality of rankings.

At 312, the method 300 may include storing, using a storage device (such as the storage device 206), the at least one preferred digital content.

At 314, the method 300 may include transmitting, using the communication device, the at least one preferred digital content to a provider device.

In some embodiments, the method 300 may further include establishing, using the communication device, a communication session between the provider device and the recipient device. Further, an identity of the provider may be anonymized.

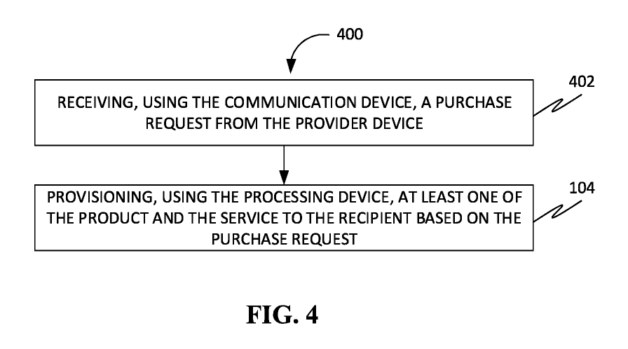

FIG. 4 is a flowchart of a method 400 of processing a purchase request, in accordance with some embodiments. Accordingly, at 402, the method 400 may include receiving, using the communication device, the purchase request from the provider device. Further, the purchase request may be associated with one or more of a product and a service represented by the at least one preferred digital content. Further, at 404, the method 400 may include provisioning, using the processing device, one or more of the product and the service to the recipient based on the purchase request.

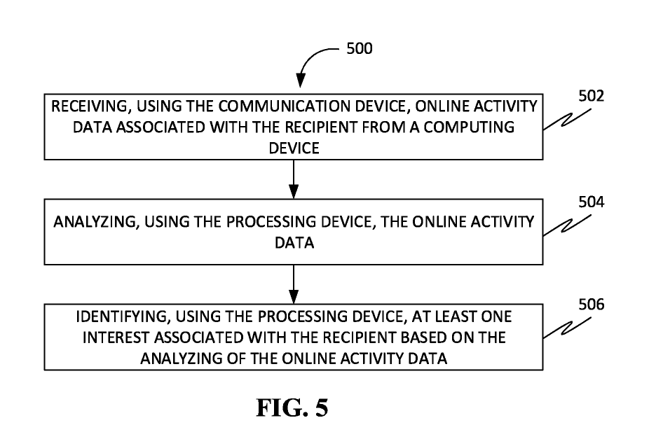

FIG. 5 is a flowchart of a method 500 of determining at least one interest associated with the recipient, in accordance with some embodiments. Accordingly, at 502, the method 500 may include receiving, using the communication device, online activity data associated with the recipient from a computing device. In some embodiments, the computing device may include the recipient device. Accordingly, the online activity data may be captured and stored at the recipient device. Further, in some embodiments, the computing device may include a server computer configured to provide one or more services to the recipient device. Accordingly, the server computer may monitor the activity of the recipient and generate the online activity data and subsequently transmit the online activity data to the online platform 100.

At 504, the method 500 may include analyzing, using the processing device, the online activity data. At 506, the method 500 may include identifying, using the processing device, at least one interest associated with the recipient based on the analyzing of the online activity data. Further, the identifying of the at least one preferred digital content may be based on the at least one interest. Accordingly, in some embodiments, subsequent to the user providing rankings to the plurality of digital content, the at least one interest may be used to modify the rankings.

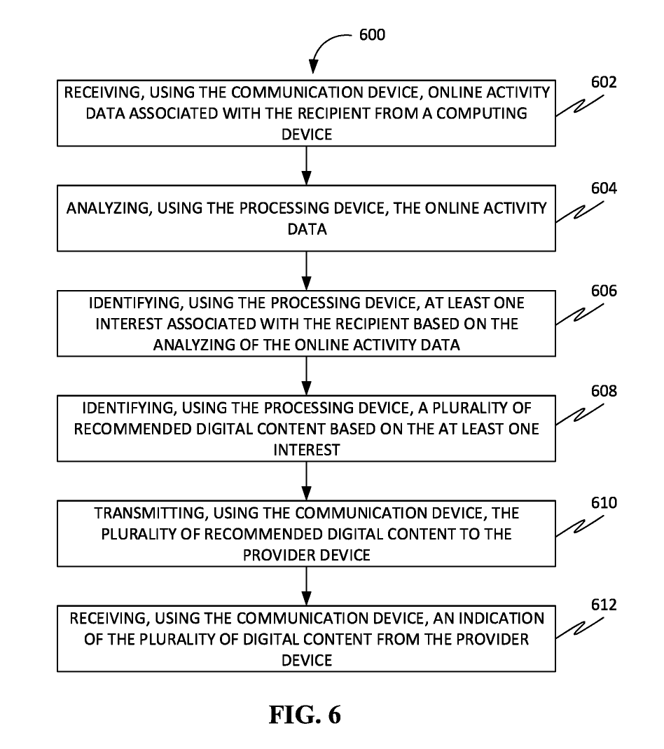

FIG. 6 is a flowchart of a method 600 of providing digital content, in accordance with some embodiments. Accordingly, at 602, the method 600 may include receiving, using the communication device, online activity data associated with the recipient from a computing device. In some embodiments, the computing device may include the recipient device. Accordingly, the online activity data may be captured and stored at the recipient device. Further, in some embodiments, the computing device may include a server computer configured to provide one or more services to the recipient device. Accordingly, the server computer may monitor activity of the recipient and generate the online activity data and subsequently transmit the online activity data to the online platform 100.

Accordingly, at 604, the method 600 may include analyzing, using the processing device, the online activity data. Accordingly, at 606, the method 600 may include identifying, using the processing device, at least one interest associated with the recipient based on the analyzing of the online activity data. Accordingly, at 608, the method 600 may include identifying, using the processing device, a plurality of recommended digital content based on the at least one interest. Accordingly, at 610, the method 600 may include transmitting, using the communication device, the plurality of recommended digital content to the provider device. In some embodiments, the online platform 100 may provide a list of recommended digital content to the provider to choose the plurality of digital content. Further, the list may be generated based on one or more interests of the recipient as gleaned from the recipient's online activity.

Accordingly, at 612, the method 600 may include receiving, using the communication device, an indication of the plurality of digital content from the provider device. Further, the plurality of recommended digital content may include the plurality of digital content.

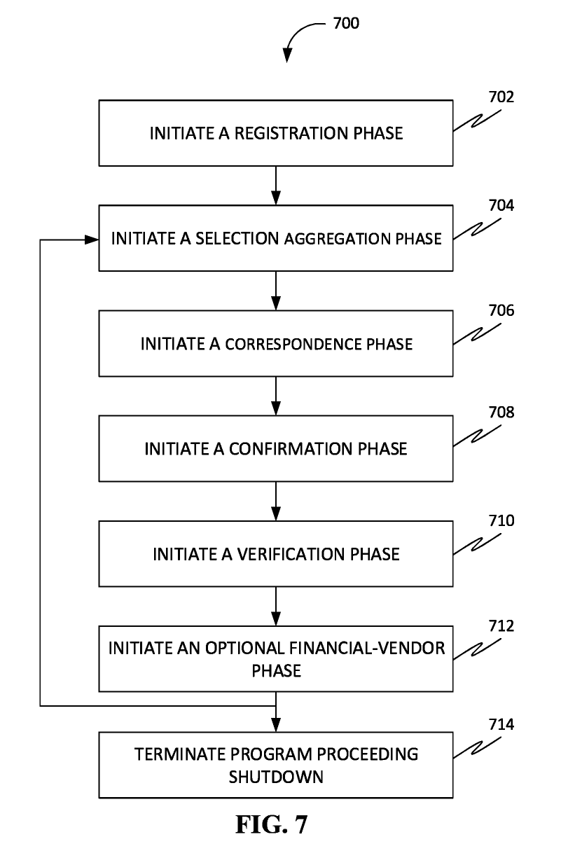

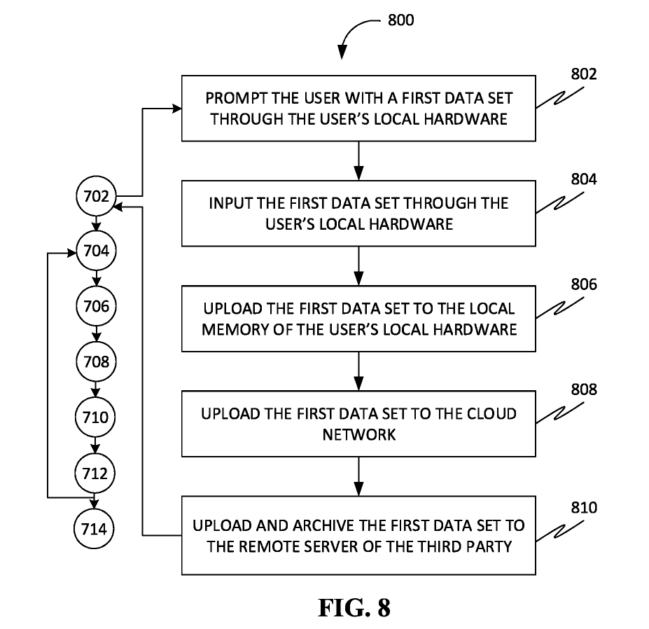

FIG. 7 is a flowchart of a method 700 for offering and receiving validation of a gift through an anonymous masking protocol, in accordance with some embodiments. The method 700 may include initiating a registration phase at 702, initiating a selection-aggregation phase at 704, initiating a correspondence phase at 706, initiating a confirmation phase at 708, initiating a verification phase at 710, and initiating an optional financial-vendor phase at 712. The steps 702-712 are explained in further detail in conjunction with FIGS. 8-13 below respectively. Further, the method 700 may include terminating program processing a shutdown at 714.

FIG. 8 is a flowchart of a method 800 for initiating the registration phase, in accordance with some embodiments. The method 800 may include prompting the user with a first data set through the user's local hardware at 802, inputting the first data set through the user's local hardware at 804, uploading the first data set to the local memory of the user's local hardware at 806, uploading the first data set to the cloud network at 808, and uploading and archiving the first data set to the remote server of the third party at 810.

Accordingly, at 802, the user is prompted with a first data set through the user's local hardware where the user may be either a first or an optional second party. The first data set may comprise data including, but not limited to: the user's name, possible aliases, potentially age, optionally any financial institution information, and other salient information or interest parameters. At 804, the first data set may be input through the user's local hardware which may be through voice to text, keyboards, mouse, pointers, touch screens, and so on to establish the user's identity where the first party is required to register and the second party may optionally register.

Thereafter, at 806, the first data set may be uploaded to the local memory of the user's hardware to enable operation and identification to the program autonomously to allow operation in the background of the user's browser. Then, at 808, the first data set is then uploaded or forwarded to the cloud network or internet and addressed or authorized to the third party solely. At 810, the first data set is then uploaded and archived to the remote server of the third party, an autonomous entity that archives the various users and their pertinent data sets.

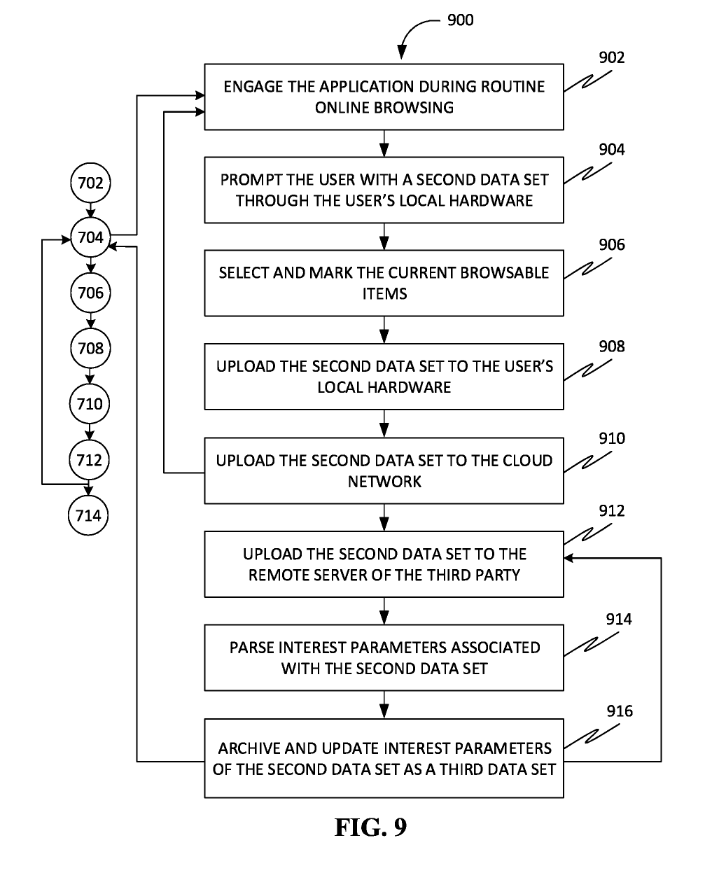

FIG. 9 is a flowchart of a method 900 for initiating the selection-aggregation phase, in accordance with some embodiments. The method 900 may include engaging the application during routine online browsing at 902, prompting the user with a second data set through the user's local hardware at 904, selecting and marking the current browsable items at 906, uploading the second data set to the user's local hardware at 908, uploading the second data set to the cloud network at 910, uploading and updating the second data set to the remote server of the third party at 912, parsing interest parameters associated with the second data set at 914, and archiving interest parameters of the second data set as a third data set; where the first five may continuously loop as may the latter three at 916.

Accordingly, at 902, the application may be engaged during routine online browsing, preferably by means of a tab, widget, bookmarklet, or other online browser extensions that are readily presented and accessible by the user. Engaging the application may preferably involve the confirmation by click, press, or verbal verification to engage the application or program to capture readily browsable articles of a purchasable quality such as an e-shop page. Thereafter, at 904, the user is prompted with a second data set through the user's local hardware such as a screen or display where the browsable articles are organized and aggregated from the online page itself. Preferably, the display thereof may be alterable in some manner to allow articles to be organized by name, price, and other salient values. Optionally, the user may note or specify the second party the user is seeking to purchase for which may initiate a uniquely instanced third data set that comprises this second party's unique interest parameters.

Then, at 906, the user may then select and mark the current browsable items or articles through engagement of the local hardware such as touch screens, keyboards, and mouse to identify desirable articles and otherwise discard all others not selected. At 908, the remaining articles are packaged and update the instanced second data set within the user's local hardware. Thereafter, at 910, the second data set is then sent to the user's local hardware to be stored locally and packaged within the purview of the application and addressed to the third party in preparation to be forwarded. The instanced second data set is then sent to the cloud network upon confirmation by the user and directed to the third party. Then, at 912, the second data set is then uploaded to the third party and updated within the remote server of the third party where each individual instance is preferably associated firstly with the user that arranged the second data set and secondly to any salient data such as an intended second party the arrangement of articles is intended for.

Through the remote server algorithm and within the remote algorithm, the interest parameters associated with the second data set are parsed (at 914) to produce a blueprint over time of the first or second party's unique interests, activities, preferences and other predictive metrics such as for instance, determining from receiving a second data set containing a bike, a backpack, and a camera for a future second entity, the algorithm will discern that the second entity enjoys the outdoors in the broadest sense and a likely hiker or camper in the most narrow sense. The interest parameters of the second data set are then aggregated together and archived as a third data set pertinent to the discretized second party at 916.

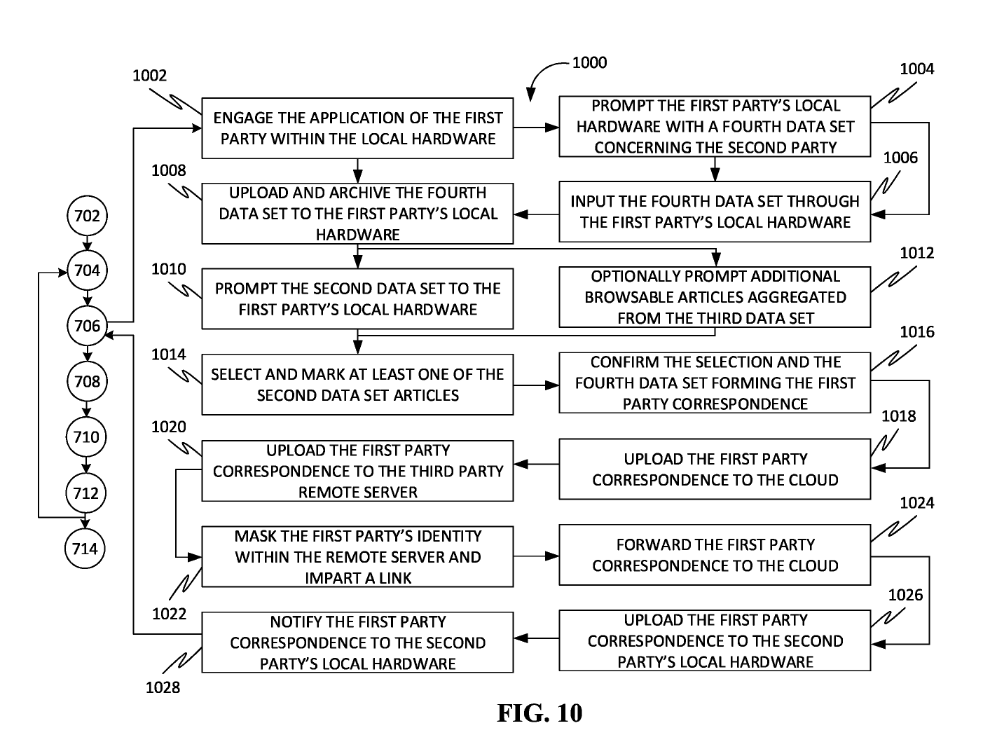

FIG. 10 is a flowchart of a method 1000 for initiating the correspondence phase, in accordance with some embodiments. The method 1000 may include engaging the application of the first party within the local hardware at 1002, prompting the first party's local hardware with a fourth data set concerning the second party at 1004, inputting the fourth data set through the first party's local hardware at 1006, and uploading and archiving the fourth data set to the first party's local hardware at 1008.

Thereafter, the method 1000 may include two simultaneous steps: prompting the second data set to the first party's local hardware at 1010, and optionally prompting additional browsable articles aggregated from the third data set at 1012.

Further, the method 1000 may include selecting and marking at least one of the second data set articles at 1014, confirming the selection and the fourth data set forming the first party correspondence at 1016, uploading the first party correspondence to the cloud at 1018, uploading the first party correspondence to the third party remote server at 1020, masking the first party's identity within the remote server and imparting a link at 1022, forwarding the first party correspondence to the cloud at 1024, uploading the first party correspondence to the second party's local hardware at 1026, and notifying the first party correspondence to the second party's local hardware at 1028.

Accordingly, at 1002, the application of the first party is engaged within the first party's local hardware by means of confirming the internet extension and electing to initiate the correspondence phase. Then, at 1004, the first party's local hardware is then prompted with a fourth data set concerning the second party and drawing upon all second data sets pertinent to the second party that the first party has prepared throughout routine online activity. The fourth data set may specifically call for an authentic address of the second party if not previously established in the second data set that may optionally include textual input alongside all archived browsing articles of the second data set. At 1006, the fourth data set is then input through the first party's local hardware by means of keyboard, voice to text, gestures, mouse, and other such means.

Thereafter, at 1008, the fourth data set is uploaded and archived to the first party's local hardware to store in preparation of forwarding to the cloud and third party. The second data set if not already prompted with the fourth data set is then prompted to the first party's local hardware that concerns all brow sable articles the first party selected and marked during the selection-aggregation phase at 1010. Further, if applicable or the user has established an extensive enough profile and third data set for the second entity, additional browsable articles aggregated from the third data set may optionally be prompted to the first party's local hardware concerning articles not selected by the first party but relevant to the second party's third data set of parsed interest parameters at 1012.

Thereafter, at 1014, the first party may then select and mark at least one of the second data set articles and if applicable any third data set related articles wherein the selection and prompting of additional browsable articles may continue until the first party provides confirmation to cease supply of additional articles to include in the fourth data set. Upon confirming the selection of the second data set and the fourth data set at 1016, the first party correspondence is formed that incorporates both the revised second data set and the fourth data set concerning the identity and any textual or salient information pertinent to the second party's identity. The first party correspondence is then uploaded to the cloud network at 1018 and subsequently the third party.

At 1020, the first party correspondence is then uploaded to the third party remote server and instanced to the unique second party pre-established by the first party during the selection-aggregation phase. Thereafter, at 1022, the first party's identity is masked within the remote server by the remote server algorithm wherein a link is imparted to the first party correspondence that may redirect to the third party and the address designation of the second party. At 1024, the first party correspondence is then forwarded to the cloud network with the intent to reach the second party. Then, at 1026, the first party correspondence is then uploaded to the second party's local hardware through email, Facebook, private Tumblr address, or other net equipped messaging system. Following conventional protocol, the first party correspondence is notified to the second party's local hardware (at 1028) through a sound, visual indication, or other means of alerting the second party if the second party has also registered themselves and possess the program presently.

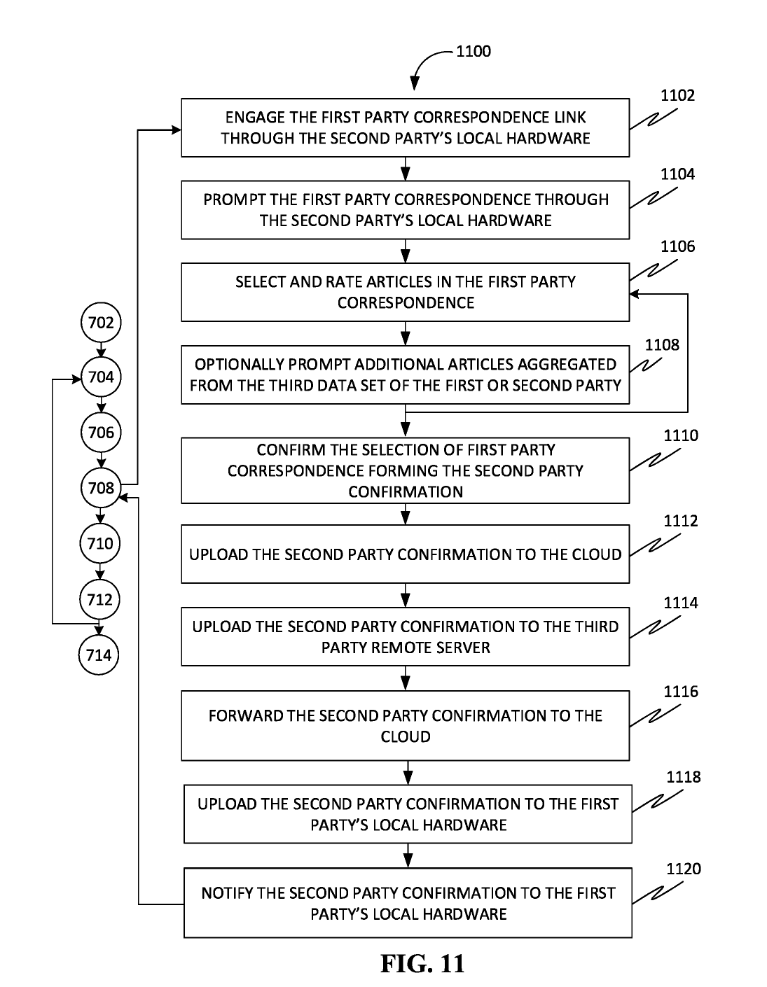

FIG. 11 is a flowchart of a method 1100 for initiating the confirmation phase, in accordance with some embodiments. The method 1100 may include engaging the first party correspondence link through the second party's local hardware at 1102, prompting the first party correspondence through the second party's local hardware at 1104, selecting and rating articles in the first party correspondence at 1106, optionally prompting additional articles aggregated from the third data set of the first or second party at 1108, confirming the selection of first party correspondence forming the second party confirmation at 1110, uploading the second party confirmation to the cloud at 1112, uploading the second party confirmation to the third party remote server at 1114, forwarding the second party confirmation to the cloud at 1116, uploading the second party confirmation to the first party's local hardware at 1120, and notifying the second party confirmation to the first party's local hardware at 1122. The method 1100 may include looping back from the step 1110 to the step 1108 indefinitely until confirmation is given.

Accordingly, at 1102, the second party may then engage the first party correspondence link through the second party's local hardware and within the purview of their own internet browser, whereupon the first party may be completely masked to the second party. At 1104, the second party may be redirected to the third party and prompted with the first party correspondence through the second party's local hardware concerning the revised second data sets established by the user and any additional information, textual or otherwise, established in the fourth data set. At 1106, the second party may then select and rate articles within the first party correspondence regarding whether they like the gifts the first party has proposed and how much they like the gifts in relation to other gifts.

If available from the same third data set established by the first user or optionally a third data set established by the second user for items they themselves may appreciate, additional articles aggregated from either of the third data sets of the first or second party may be optionally prompted at 1108. Thereafter, the second party may then select and mark in a continual supply of suggestions until confirmation is given by the second party to cease suggestions. Upon final confirmation concerning the selection of the first party correspondence, the second party confirmation is formed at 1110. The second party confirmation may contain directly what the second party desires in the form of a gift which may include several items proposed by the first party and several items proposed by the second party in a typical engagement. The second party confirmation is then uploaded to the cloud network and directed to the third party at 1112.

Then, at 1114, the second party confirmation is then uploaded to the third party remote server wherein the remote server algorithm may make note of any aberrations of the second party, parsing the aberrations, and updating the third data set accordingly. At 1116, the second party confirmation is then forwarded to the cloud and addressed to the first party.

Thereafter, at 1118, the second party confirmation is uploaded to the first party's local hardware preferably through the program. At 1120, the second party confirmation is notified to the first party's local hardware preferably through the program but may be presented through email, messaging, and other means detailing the desires and thoughts of the second party. Further, the user may be alerted by assorted means such as auditory notification or visual notification at the point of receiving the second party confirmation.

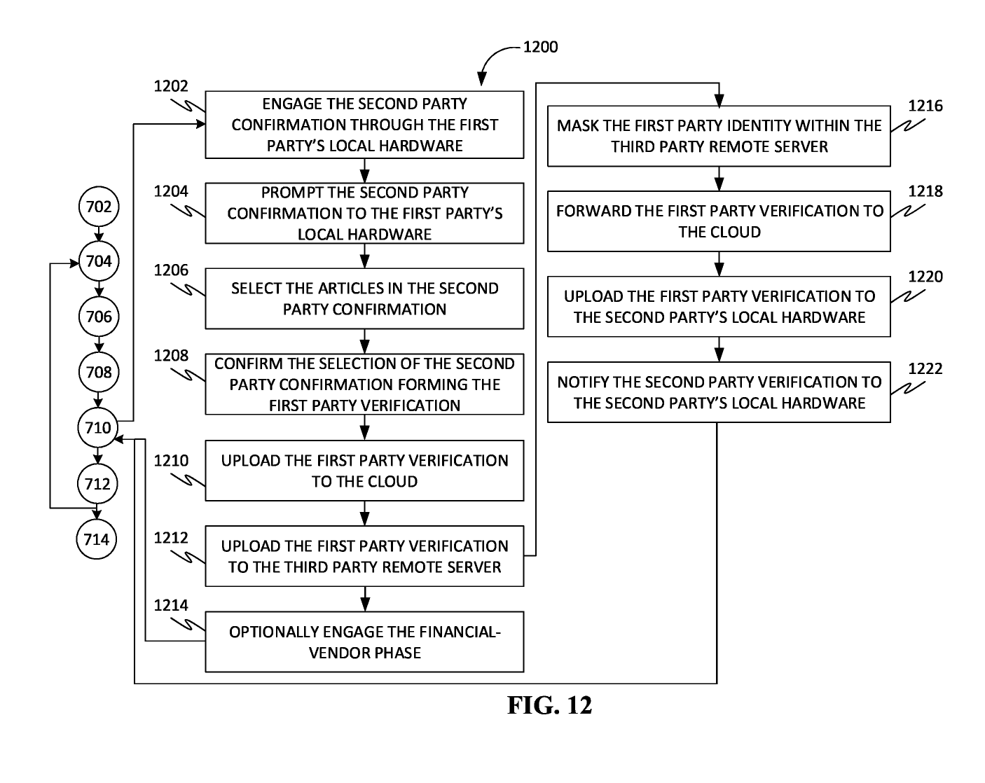

FIG. 12 is a flowchart of a method 1200 for initiating the verification phase, in accordance with some embodiments. The method 1200 may include engaging the second party confirmation through the first party's local hardware at 1202, prompting the second party confirmation to the first party's local hardware at 1204, selecting the articles in the second party confirmation at 1206, confirming the selection of the second party confirmation forming the first party verification at 1208, uploading the first party verification to the cloud at 1210, uploading the first party verification to the third party remote server at 1212, masking the first party identity within the third party remote server at 1216, forwarding the first party verification to the cloud at 1218, uploading the first party verification to the second party's local hardware at 1220, and notifying the second party verification to the second party's local hardware at 1222. Further, the method 1200 may include an optional step 1214 for optionally engaging the optional financial-vendor phase, may occur simultaneously with the sixth step that may operate the proceeding financial-vendor phase simultaneously with the verification phase.

Accordingly, at 1202, the second party confirmation may be engaged by the first party through the first party's local hardware by selecting the internet extension of the program preferably or otherwise accessed by email. Then at 1204, the second confirmation is prompted to the first party's local hardware detailing the thoughts and desires of the second party concerning the list of gifts offered by the first party and any additional gifts proposed by the second party. At 1206, the first party may then select the articles in the second party confirmation supplied by the second party that are either the highest rated, cheapest priced, or what the first party most wants to see the second party receive with some deference to the rating and desire noted by the second party.

Subsequently, at 1208, the first party may confirm the selections of the second party confirmation forming the first party verification that may contain a gift at least modestly desired by the second party. Additionally, the first party may impart additional textual context or sentiments to the first party confirmation and paired alongside the articles selected. At 1210, the first party verification is then uploaded with the cloud and addressed to the third party. Thereafter, at 1212, the first party verification is then uploaded to the third party remote server and where the remote server algorithm may note any final alterations to the order and reflect such changes in the third data set relative to the instanced second party.

If applicable, the optional financial-vendor phase may optionally be engaged (at 1214) upon which the optional financial-vendor phase may occur simultaneously with the verification phase for the remainder of the program or insofar the instanced protocol concerns the discretized second party. At 1216, the first party identity is then masked within the third party remote server and addressed primarily to the second party and in the enhanced embodiment forwarded to the optional fourth and fifth party if applicable.

At 1218, the first party verification is then forwarded to the cloud network to the pertinent parties established prior. Thereafter, at 1220, the first party verification is definitively uploaded to the second party's local hardware either through messaging systems or through the program of the internet extension if previously installed. At 1222, the second party verification is then notified to the second party's local hardware, either through messaging protocols, or through an auditory or visual notification through the internet extension program.

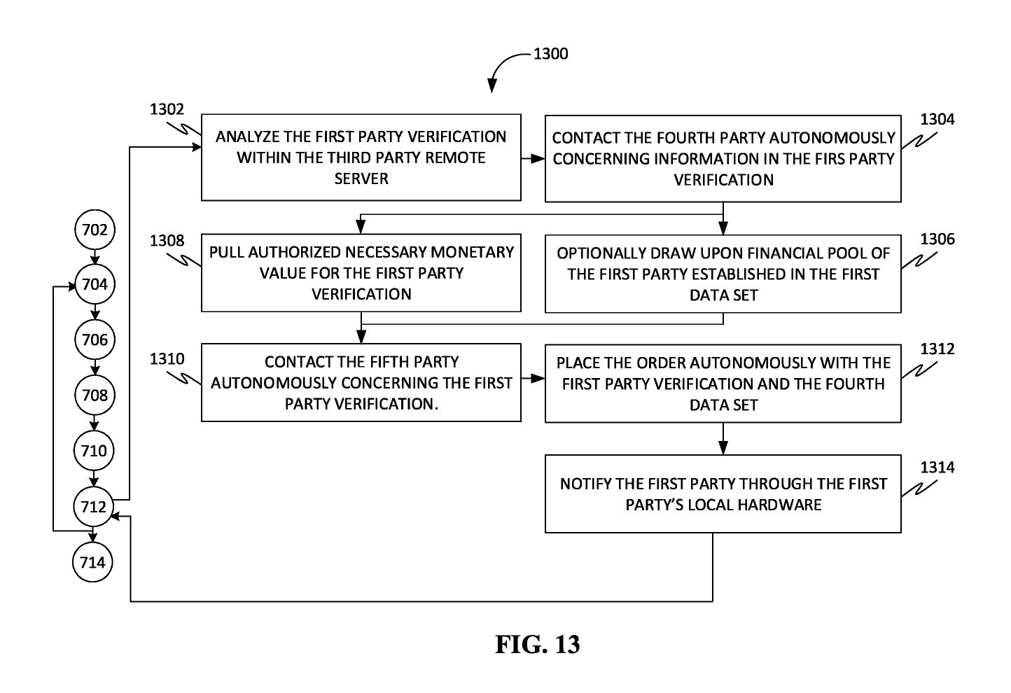

FIG. 13 is a flowchart of a method 1300 for initiating the optional financial vendor phase, in accordance with some embodiments. The method 1300 may include the first party verification within the third party remote server at 1302, and contacting the fourth party autonomously concerning information in the first party verification at 1304. Further, the method 1300 may include two simultaneous steps: pulling authorized necessary monetary value for the first party verification at 1306, and optionally drawing upon financial pool of the first party established in the first data set at 1308. Further, the method 1300 may include contacting the fifth party autonomously concerning the first party verification at 1310, placing the order autonomously with the first party verification and the fourth data set at 1312, and notifying the first party through the first party's local hardware at 1314.

If the optional financial-vendor phase is present in an enhanced embodiment, the phase thereof may initiate midway through the verification phase. The optional financial-vendor phase may optionally possess a readily available financial pool established by the user at the onset of registration that the user may transfer funds to either autonomously or on demand. Otherwise the protocol may request the funds from the optional fourth party on demand with authorization by the user. The optional financial-vendor phase may then initiate by analyzing the first party verification within the third party remote server (at 1302) for the articles desired and confirmed articles, their point-of-sale or means of procurement.

At 1304, the third party may then contact the fourth party autonomously coincident with forwarding the first party verification to the cloud concerning information in the first party verification and collecting the necessary funds prior to placing any autonomous order and preferably alerting and requiring confirmation by the first party either within the scope of the first party verification or a post confirmation following completion of the first party verification. Thereafter, necessary monetary value and funds are pulled where authorized by the first party relevant and tied to the first party verification at 1306. Optionally, at 1308, the third party may draw upon a financial pool of the first party established in the first data set at the first party's registration phase whereupon the first party may periodically or autonomously supply funds to the financial pool.

Upon successfully acquiring the necessary financial funds from the first party either form the optional fourth party or a pre-established financial pool, the third party contacts the optional fifth party autonomously concerning details of the first party verification at 1310. Such details may include but are not limited to the specific article, possibly shipping date and rate as pre-established by the first entity when composing the first party verification, and any additional memorandum or textual context to be relayed to the second party or acted upon by the optional fifth party where all transactions are conducted by the third entity in name and authority but supplied the necessary funds by the first party.

The, at 1312, the order, relevant to the first party verification, is then placed autonomously by the third party to the optional fifth party with information additionally concerning the fourth data set to address and ship the article if the first party is aware of the second party's physical address. Elsewise, the gift may be put in hold and inform the second party independently that the gift is available to them with the supply of shipping information. Lastly, at 1314, the first party is notified by a parting correspondence through the first party's local hardware concerning success of the purchase and shipping of the articles desired by the second party and an expectation of when the article may arrive and any necessary salient documents for personal records and archival.

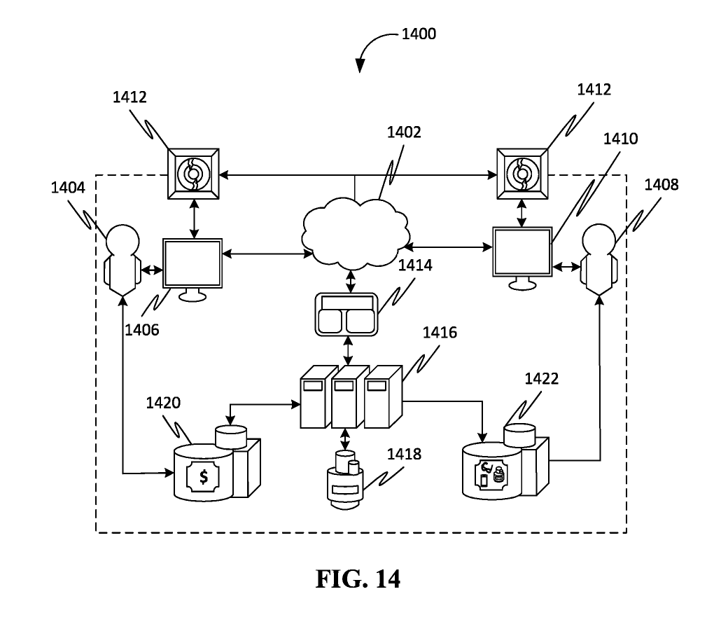

FIG. 14 illustrates a system 1400 for offering and receiving validation of a gift through an anonymous masking protocol, in accordance with some embodiments. The system 1400 may include a cloud network/internet 1402 that communicates between the first, second, third, optional fourth, and optional fifth party as well as the programs of the first and second party's local hardware. The first party (or user) 1404 may be required to register prior to operation of the program and communicates with the optional fourth party to authorize financial reserves to the third party. The system 1400 may include the first party's local hardware 1406 that may be a computer, PDA, smartphone smart watch, and so on, and is operated by the user, runs the program, and communicates with the cloud network 1402.

Further, the second party 1408 is the receiving party and may communicate with the second party's local hardware 1410 and receives the gift from the optional fifth party. The system 1400 may include the second party's local hardware 1410 that operates the program for the second party, is directly operated by the second party and communicates with the cloud network.

Moreover, the first and second party's local hardware 1406, 1410 communicates and operates through and draws information from the cloud network/internet via the program 1412.

The third party 1414 operates as the mediating party and communicates to the cloud network 1402 directly channeling the correspondence, confirmation, and verification sent across the cloud network. The third party further communicates with the remote server 1416. The remote server 1416 stores the various information of the first and second party and may also communicate with the optional fourth party, the remote server algorithm, the third entity, and may also output orders to the optional fifth party;

The remote server 1416 includes a remote server algorithm 1418 that evaluates the parsed interest parameters produced from the second data set to produce the third data set and handles the masking protocols and automated allocation of funds from the optional fourth party and preparation of orders to the optional fifth entity.

The optional fourth party 1420 embodies a financial institution of the first party's in order to allocate funds to their account within the remote server. Further, the optional fifth party 1422 may be an enhanced embodiment receives orders from the remote server, and likely through the cloud, with information proceeding the first party verification and forwarding the order/gift to the second party.

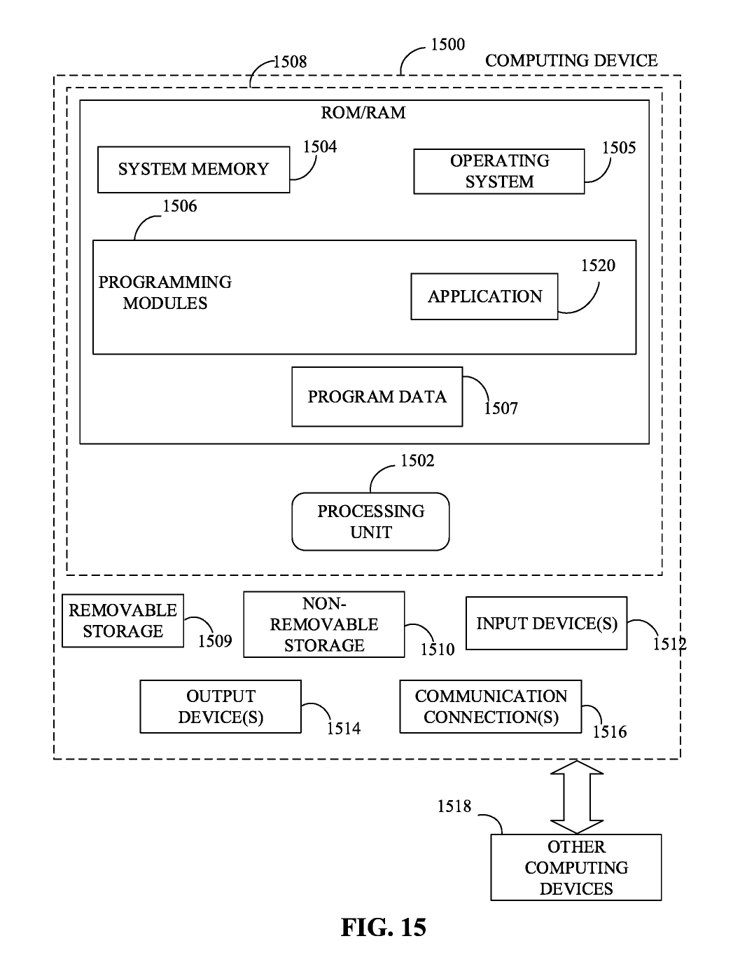

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500′s operation. In one embodiment, programming modules 1506 may include machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include data processing application, machine learning application, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

What is claimed is:

1. A method of facilitating recommendation of digital content based on user responses, the method comprising:
receiving, using a communication device, a plurality of digital content from a provider device.
transmitting, using the communication device, the plurality of digital content to a recipient device, wherein the recipient device is configured to present the plurality of digital content;
receiving, using the communication device, at least one response from the recipient device, wherein the at least one response is associated with the plurality of digital content, wherein the recipient device comprises at least one response capturing device configured to capture the at least one response;
analyzing, using a processing device, the at least one response;
identifying, using the processing device, at least one preferred digital content based on the analyzing; and
storing, using a storage device, the at least one preferred digital content;
transmitting, using the communication device, the at least one preferred digital content to a provider device.

2. The method of claim 1, wherein the at least one response capturing device comprises an input device configured to receive an input from a recipient of the recipient device.

3. The method of claim 1, wherein the at least one response capturing device comprises an image capturing device configured to capture at least one image of a recipient of the recipient device in response to presentation of at least one digital content of the plurality of digital content.

4. The method of claim 1, wherein the at least one response capturing device comprises a physiological sensor configured to detect at least one physiological variable of a recipient of the recipient device in response to presentation of at least one digital content of the plurality of digital content.

5. The method of claim 1, wherein the at least one response capturing device comprises an IoT device configured to detect at least one offline behavior of a recipient of the recipient device in an environment, wherein the identifying of the at least one preferred digital content is based further on the at least one offline behavior.

6. The method of claim 1 further comprising:
receiving, using the communication device, a purchase request from the provider device, wherein the purchase request is associated with at least one of a product and a service represented by the at least one preferred digital content; and
provisioning, using the processing device, at least one of the product and the service to the recipient based on the purchase request.

7. The method of claim 1, wherein the at least one response comprises a plurality of rankings corresponding to the plurality of digital content, wherein identifying of the at least one preferred digital content is based on the plurality of rankings.

8. The method of claim 1 further comprising:
receiving, using the communication device, online activity data associated with the recipient from a computing device;
analyzing, using the processing device, the online activity data; and
identifying, using the processing device, at least one interest associated with the recipient based on the analyzing of the online activity data, wherein the identifying of the at least one preferred digital content is based further on the at least one interest.

9. The method of claim 1 further comprising establishing, using the communication device, a communication session between the provider device and the recipient device, wherein an identity of the provider is anonymized.

10. The method of claim 1 further comprising:
receiving, using the communication device, online activity data associated with the recipient from a computing device;
analyzing, using the processing device, the online activity data;
identifying, using the processing device, at least one interest associated with the recipient based on the analyzing of the online activity data;
identifying, using the processing device, a plurality of recommended digital content based on the at least one interest;
transmitting, using the communication device, the plurality of recommended digital content to the provider device; and
receiving, using the communication device, an indication of the plurality of digital content from the provider device, wherein the plurality of recommended digital content comprises the plurality of digital content.

11. A system for facilitating recommendation of digital content based on user responses, the system comprising:
a communication device configured for:
receiving a plurality of digital content from a provider device.
transmitting the plurality of digital content to a recipient device, wherein the recipient device is configured to present the plurality of digital content;
receiving at least one response from the recipient device, wherein the at least one response is associated with the plurality of digital content, wherein the recipient device comprises at least one response capturing device configured to capture the at least one response;
transmitting at least one preferred digital content to a provider device;
a processing device configured for:
analyzing the at least one response;
identifying the at least one preferred digital content based on the analyzing; and
a storage device configured for storing the at least one preferred digital content.

12. The system of claim 11, wherein the at least one response capturing device comprises an input device configured to receive an input from a recipient of the recipient device.

13. The system of claim 11, wherein the at least one response capturing device comprises an image capturing device configured to capture at least one image of a recipient of the recipient device in response to presentation of at least one digital content of the plurality of digital content.

14. The system of claim 11, wherein the at least one response capturing device comprises a physiological sensor configured to detect at least one physiological variable of a recipient of the recipient device in response to presentation of at least one digital content of the plurality of digital content.

15. The system of claim 11, wherein the at least one response capturing device comprises an IoT device configured to detect at least one offline behavior of a recipient of the recipient device in an environment, wherein the identifying of the at least one preferred digital content is based further on the at least one offline behavior.

16. The system of claim 11, wherein the communication device is further configured for receiving a purchase request from the provider device, wherein the purchase request is associated with at least one of a product and a service represented by the at least one preferred digital content, wherein the processing device is further configured for provisioning at least one of the product and the service to the recipient based on the purchase request.

17. The system of claim 11, wherein the at least one response comprises a plurality of rankings corresponding to the plurality of digital content, wherein identifying of the at least one preferred digital content is based on the plurality of rankings.

18. The system of claim 11, wherein the communication device is further configured for receiving online activity data associated with the recipient from a computing device, wherein the processing device is further configured for:
analyzing the online activity data; and
identifying at least one interest associated with the recipient based on the analyzing of the online activity data, wherein the identifying of the at least one preferred digital content is based further on the at least one interest.

19. The system of claim 11 further comprising establishing a communication session between the provider device and the recipient device, wherein an identity of the provider is anonymized.

20. The system of claim 11, wherein the communication device is further configured for:
receiving online activity data associated with the recipient from a computing device;
transmitting a plurality of recommended digital content to the provider device; and
receiving an indication of the plurality of digital content from the provider device, wherein the plurality of recommended digital content comprises the plurality of digital content, wherein the processing device is further configured for:
analyzing the online activity data;
identifying at least one interest associated with the recipient based on the analyzing of the online activity data; and
identifying the plurality of recommended digital content based on the at least one interest.
